(19) United States
(12) Patent Application Publication
(10) Pub. No.: US 2026/0065709 A1
(43) Pub. Date: Mar. 5, 2026

(54) ELECTRONIC DEVICE FOR IDENTIFYING A HAND AND METHOD FOR CONTROLLING THE SAME

(71) Applicant: Samsung Electronics Co., Ltd., Suwon-si (KR)

(72) Inventors: Akula JAYAPRAKASH, Bangalore (IN); Green Rosh KS, Bangalore (IN); Bindigan Hariprasanna PAWAN PRASAD, Bangalore (IN); Vishakha SR, Bangalore (IN); Prateek KUKREJA, Bangalore (IN); Meghana SHANKAR, Bangalore (IN); Shubham Mallik THAKUR, Bangalore (IN); Sagar PARMAR, Bangalore (IN); Sungsoo CHOI, Suwon-si (KR); Hyuntaek WOO, Suwon-si (KR)

(21) Appl. No.: 19/086,862

(22) Filed: Mar. 21, 2025

Related U.S. Application Data
(63) Continuation of application No. PCT/KR2025/099794, filed on Mar. 13, 2025.

(30) Foreign Application Priority Data
Sep. 4, 2024 (IN) 202441066842

(51) Int. Cl. G06V 40/10; G01S 7/48; G06T 7/73; G06V 10/25; G06V 10/34; G06V 10/44; G06V 10/764; H04N 23/20; H04N 23/56

(52) U.S. Cl. CPC G06V 40/107; G01S 7/4802; G06T 7/73; G06V 10/25; G06V 10/34; G06V 10/44; G06V 10/764; H04N 23/20; H04N 23/56; G06T 2207/10048; G06T 2207/30196

(57) ABSTRACT

A method for identifying a hand is provided. The method includes obtaining, via a ToF sensor of the electronic device, at least one image, wherein the at least one image includes a hand, and the TOF sensor emits infrared (IR) light and receives IR reflection of the IR light emitted from the ToF sensor, identifying a plurality of key points associated with the hand in the at least one image, generating a reflectivity map of the hand based on the reflection of the IR light received by the ToF sensor, identifying a plurality of regions of the hand in the at least one image using the reflectivity map and the plurality of key points, and based on the identified plurality of regions, identifying the hand as either a left hand or a right hand.

### CROSS-REFERENCE TO RELATED APPLICATION(S)

This application is a continuation application, claiming priority under § 365(c), of an International application No. PCT/KR2025/099794, filed on Mar. 13, 2025, which is based on and claims the benefit of an Indian patent application number 202441066842, filed on Sep. 4, 2024, in the Indian Intellectual Property Office, the disclosure of which is incorporated by reference herein in its entirety.

### FIELD OF THE INVENTION

The disclosure relates to a method for identifying a hand and method for controlling the same.

### BACKGROUND

Modern computing and display technologies have enabled the development of systems for “virtual reality,” “augmented reality,” or “mixed reality” experiences, where digitally reproduced images, or portions thereof, are presented to users in a way that makes these appear or be perceived as real. In an augmented reality (AR) scenario, digital or virtual image information is typically presented as an enhancement to the users' view of the actual world around them. For instance, an AR scene might allow a user to see virtual objects superimposed on or integrated with real-world objects, such as a park setting with people, trees, and buildings in the background. This significantly enhances the users' experience and opens up numerous applications that enable users to simultaneously experience real and virtual objects.

AR systems have potential applications across a wide range of fields, including scientific visualization, medicine, military training, engineering design and prototyping, tele-manipulation and telepresence, and personal entertainment. However, providing a realistic augmented reality experience presents significant challenges. To accurately correlate the location of virtual objects with real objects, an AR system must constantly be aware of a user's physical surroundings. Additionally, the AR system must correctly position virtual objects in relation to the user's head, body, and other parts. Since users typically interact with their environment using their hands, the AR systems must track the position and orientation of the user's hands.

Hand-tracking techniques, such as using a red, green, and blue (RGB) sensor, are commonly employed for this purpose.

FIGS. 1 and 2 illustrate existing techniques to identify hand in an AR environment, according to the related art.

Referring to FIGS. 1 and 2, RGB sensors are ineffective in low-light conditions (around 1 lux or lower). For example, as illustrated in FIG. 1, the image captured is noisy and the hand is not easily visible. To address this issue, infrared (IR) based time-of-flight (ToF) sensors are used for hand tracking in low light. These sensors are utilized in AR systems, such as video-see-through (VST) devices, to achieve accurate 3-dimensional (3D) localization of hands in low light and low power modes. Nevertheless, determining handedness, i.e., identifying the hand as the left hand or the right hand using Depth/IR data from the ToF sensors is challenging. The depth data typically lacks distinguishing features, making it difficult to classify a hand as left or right, as shown in FIG. 2. The IR-based depth images 201 for both hands look similar. Particularly, the ToF images 203, which are depth images, do not provide the finer details needed to differentiate the back of the palm from the front. Consequently, distinguishing between the left and right hands in low-light conditions is problematic. Additionally, ToF images struggle to differentiate the left and right hands in scenarios where the hands cross each other or when one hand moves to the opposite side.

Therefore, there exists a need to develop techniques for accurately identifying a hand in the AR and virtual reality (VR) systems, while addressing at least the aforementioned challenges.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method for identifying a hand in an augmented reality based head mounted device (HMD) and an HMD therefore.

Additional aspects will be set forth in part in the description which follows and, in part, will be apparent from the description, or may be learned by practice of the presented embodiments.

In accordance with an aspect of the disclosure, a method for identifying a hand is provided. The method includes obtaining, via a ToF sensor of the electronic device, at least one image, wherein the at least one image includes a hand, and the TOF sensor emits infrared (IR) light and receives IR reflection of the IR light emitted from the ToF sensor, identifying a plurality of key points associated with the hand in the at least one image, generating a reflectivity map of the hand based on the reflection of the IR light received by the ToF sensor, identifying a plurality of regions of the hand in the at least one image using the reflectivity map and the plurality of key points, and based on the identified plurality of regions, identifying the hand as either a left hand or a right hand.

In accordance with another aspect of the disclosure, an electronic device for identifying a hand in is provided. The electronic device includes memory storing one or more computer programs, a time-of-flight (ToF) sensor, and one or more processors communicatively coupled to the memory and the ToF sensor, wherein the one or more computer programs include computer-executable instructions that, when executed by the one or more processors individually or collectively, cause the electronic device to, obtain, via the ToF sensor, at least one image, wherein the at least one image includes a hand, and the TOF sensor emits infrared (IR) light and receives IR reflection of the IR light emitted from the ToF sensor, identify a plurality of key points associated with the hand in the at least one image, generate a reflectivity map of the hand based on the reflection of the IR light received by the ToF sensor, identify a plurality of regions of the hand in the at least one image using the reflectivity map and the plurality of key points, and based on the identified plurality of regions, identify the hand as either a left hand or a right hand.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include obtaining, via a ToF sensor of the electronic device, at least one image, wherein the at least one image includes a hand, and the TOF sensor emits infrared (IR) light and receives IR reflection of the IR light emitted from the ToF sensor, identifying a plurality of key points associated with the hand in the at least one image, generating a reflectivity map of the hand based on the reflection of the IR light received by the ToF sensor, identifying a plurality of regions of the hand in the at least one image using the reflectivity map and the plurality of key points, and based on the identified plurality of regions, identifying the hand as either a left hand or a right hand.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIGS. 1 and 2 illustrate existing techniques to identify hand in an augmented reality (AR) environment, according to the related art;

FIG. 3A is a block diagram illustrating an electronic device in a network environment according to various embodiments;

FIG. 3B illustrates an AR environment, according to an embodiment of the disclosure;

FIG. 3C illustrates a block diagram of a head mounted device (HMD) for identifying a hand in an AR environment, according to an embodiment of the disclosure;

FIG. 4 illustrates a flow diagram depicting a method for identifying a hand in an AR based HMD, according an embodiment of the disclosure;

FIG. 5 illustrates a scenario for generating the reflectivity map, according to an embodiment of the disclosure;

FIG. 6 illustrates a workflow diagram of a categorization module, according to an embodiment of the disclosure;

FIG. 7 illustrates a local coordinate system, according to an embodiment of the disclosure;

FIG. 8 illustrates a block diagram for recognition of hand gesture, according to an embodiment of the disclosure; and

FIGS. 9A and 9B are diagrams illustrating a wearable device (e.g., the HMD) according to various embodiments of the disclosure.

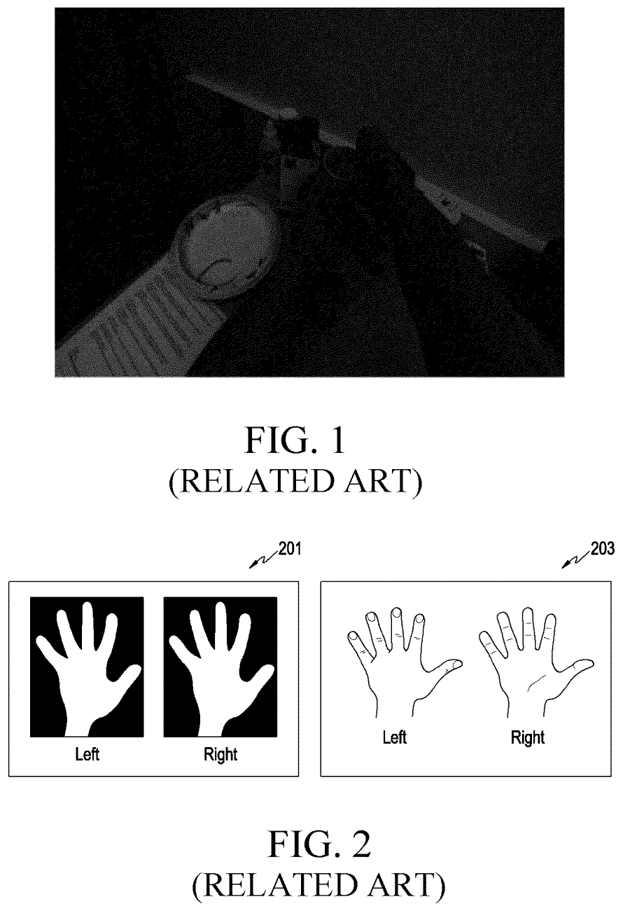

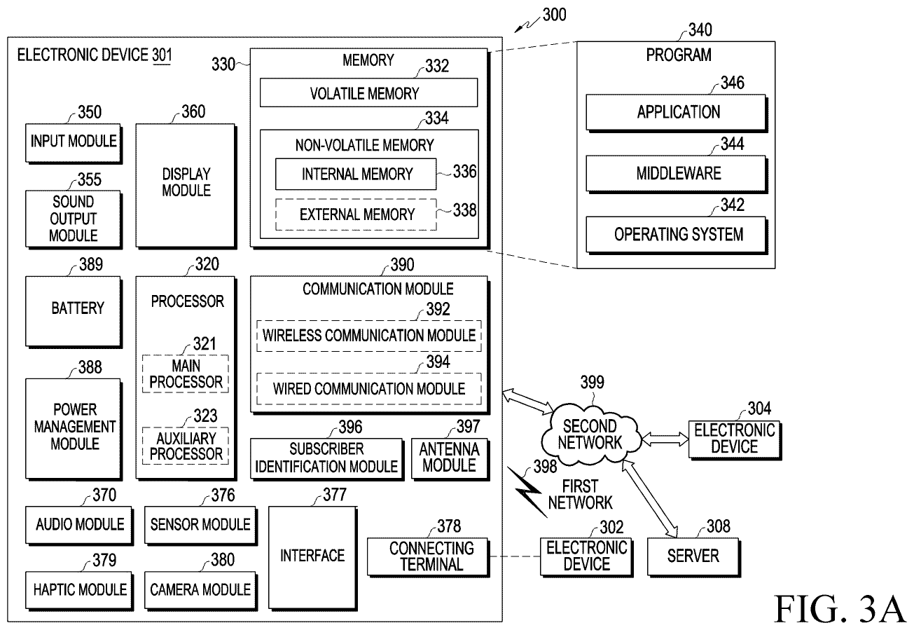

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the disclosure. Accordingly, it should be apparent to those skilled in the art that the following description of various embodiments of the disclosure is provided for illustration purposes only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It will be understood by those skilled in the art that the foregoing general description and the following detailed description are explanatory of the disclosure and are not intended to be restrictive thereof.

Reference throughout this specification to “an aspect”, “another aspect” or similar language means that a particular feature, structure, or characteristic described in connection with the embodiment is included in at least one embodiment of the disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The disclosure provides techniques for identifying a hand as either the left hand or the right hand in an AR environment. In one embodiment, this identification is achieved using depth data obtained from an IR-based sensor. Traditional methods, such as neural network-based classifiers, struggle with this task because depth data from IR images lacks distinctive hand features. Consequently, these methods often fail to accurately identify the hand as either the left hand or the right hand. To address this issue, the disclosure introduces techniques for hand identification that are effective even in low-light conditions where only IR sensor data is available.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

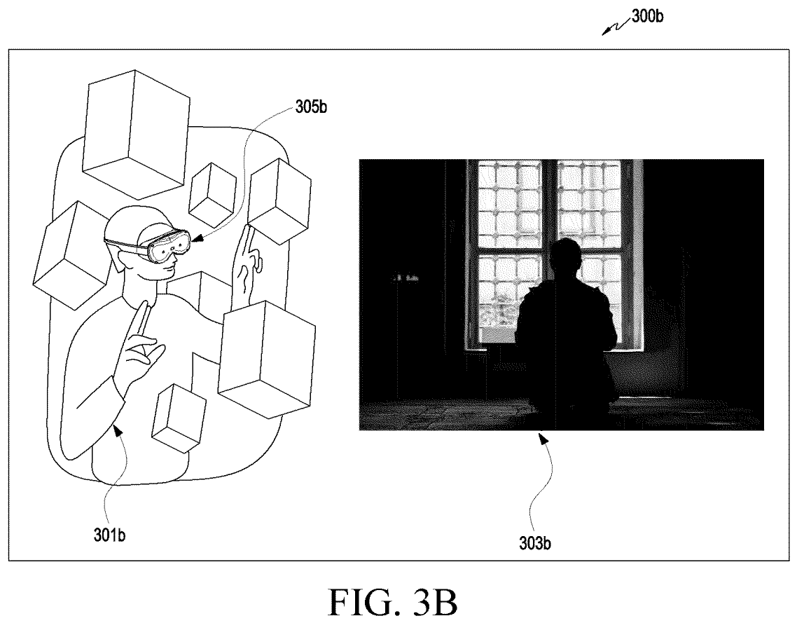

The disclosed techniques are further explained in detail with respect to FIGS. 3A, 3B, 3C, 4, 5, 6, and 7.

FIG. 3A is a block diagram illustrating an electronic device 301 in a network environment 300 according to various embodiments. Referring to FIG. 3, the electronic device 301 in the network environment 300 may communicate with an electronic device 302 via a first network 398 (e.g., a short-range wireless communication network), or at least one of an electronic device 304 or a server 308 via a second network 399 (e.g., a long-range wireless communication network). According to an embodiment, the electronic device 301 may communicate with the electronic device 304 via the server 308. According to an embodiment, the electronic device 301 may include a processor 320, memory 330, an input 3module 350, a sound output 3module 355, a display 3module 360, an audio module 370, a sensor module 376, an interface 377, a connecting terminal 378, a haptic module 379, a camera module 380, a power management module 388, a battery 389, a communication module 390, a subscriber identification module (SIM) 396, or an antenna module 397. In some embodiments, at least one of the components (e.g., the connecting terminal 378) may be omitted from the electronic device 301, or one or more other components may be added in the electronic device 301. In some embodiments, some of the components (e.g., the sensor module 376, the camera module 380, or the antenna module 397) may be implemented as a single component (e.g., the display module 360).

The processor 320 may execute, for example, software (e.g., a program 340) to control at least one other component (e.g., a hardware or software component) of the electronic device 301 coupled with the processor 320, and may perform various data processing or computation. According to one embodiment, as at least part of the data processing or computation, the processor 320 may store a command or data received from another component (e.g., the sensor module 376 or the communication module 390) in volatile memory 332, process the command or the data stored in the volatile memory 332, and store resulting data in non-volatile memory 334. According to an embodiment, the processor 320 may include a main processor 321 (e.g., a central processing unit (CPU) or an application processor (AP)), or an auxiliary processor 323 (e.g., a graphics processing unit (GPU), a neural processing unit (NPU), an image signal processor (ISP), a sensor hub processor, or a communication processor (CP)) that is operable independently from, or in conjunction with, the main processor 321. For example, when the electronic device 301 includes the main processor 321 and the auxiliary processor 323, the auxiliary processor 323 may be adapted to consume less power than the main processor 321, or to be specific to a specified function. The auxiliary processor 323 may be implemented as separate from, or as part of the main processor 321.

The auxiliary processor 323 may control at least some of functions or states related to at least one component (e.g., the display 3module 360, the sensor module 376, or the communication module 390) among the components of the electronic device 301, instead of the main processor 321 while the main processor 321 is in an inactive (e.g., sleep) state, or together with the main processor 321 while the main processor 321 is in an active state (e.g., executing an application). According to an embodiment, the auxiliary processor 323 (e.g., an image signal processor or a communication processor) may be implemented as part of another component (e.g., the camera module 380 or the communication module 390) functionally related to the auxiliary processor 323. According to an embodiment, the auxiliary processor 323 (e.g., the neural processing unit) may include a hardware structure specified for artificial intelligence model processing. An artificial intelligence model may be generated by machine learning. Such learning may be performed, e.g., by the electronic device 301 where the artificial intelligence is performed or via a separate server (e.g., the server 308). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 330 may store various data used by at least one component (e.g., the processor 320 or the sensor module 376) of the electronic device 301. The various data may include, for example, software (e.g., the program 340) and input data or output data for a command related thereto. The memory 330 may include the volatile memory 332 or the non-volatile memory 334.

The program 340 may be stored in the memory 330 as software, and may include, for example, an operating system (OS) 342, middleware 344, or an application 346.

The input 3module 350 may receive a command or data to be used by another component (e.g., the processor 320) of the electronic device 301, from the outside (e.g., a user) of the electronic device 301. The input 3module 350 may include, for example, a microphone, a mouse, a keyboard, a key (e.g., a button), or a digital pen (e.g., a stylus pen).

The sound output 3module 355 may output sound signals to the outside of the electronic device 301. The sound output 3module 355 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display 3module 360 may visually provide information to the outside (e.g., a user) of the electronic device 301. The display 3module 360 may include, for example, a display, a hologram device, or a projector and control circuitry to control a corresponding one of the display, hologram device, and projector. According to an embodiment, the display 3module 360 may include a touch sensor adapted to detect a touch, or a pressure sensor adapted to measure the intensity of force incurred by the touch.

The audio module 370 may convert a sound into an electrical signal and vice versa. According to an embodiment, the audio module 370 may obtain the sound via the input 3module 350, or output the sound via the sound output 3module 355 or a headphone of an external electronic device (e.g., an electronic device 302) directly (e.g., wiredly) or wirelessly coupled with the electronic device 301.

The sensor module 376 may detect an operational state (e.g., power or temperature) of the electronic device 301 or an environmental state (e.g., a state of a user) external to the electronic device 301, and then generate an electrical signal or data value corresponding to the detected state. According to an embodiment, the sensor module 376 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 377 may support one or more specified protocols to be used for the electronic device 301 to be coupled with the external electronic device (e.g., the electronic device 302) directly (e.g., wiredly) or wirelessly. According to an embodiment, the interface 377 may include, for example, a high definition multimedia interface (HDMI), a universal serial bus (USB) interface, a secure digital (SD) card interface, or an audio interface.

A connecting terminal 378 may include a connector via which the electronic device 301 may be physically connected with the external electronic device (e.g., the electronic device 302). According to an embodiment, the connecting terminal 378 may include, for example, a HDMI connector, a USB connector, a SD card connector, or an audio connector (e.g., a headphone connector).

The haptic module 379 may convert an electrical signal into a mechanical stimulus (e.g., a vibration or a movement) or electrical stimulus which may be recognized by a user via his tactile sensation or kinesthetic sensation. According to an embodiment, the haptic module 379 may include, for example, a motor, a piezoelectric element, or an electric stimulator.

The camera module 380 may capture a still image or moving images. According to an embodiment, the camera module 380 may include one or more lenses, image sensors, image signal processors, or flashes.

The power management module 388 may manage power supplied to the electronic device 301. According to one embodiment, the power management module 388 may be implemented as at least part of, for example, a power management integrated circuit (PMIC).

The battery 389 may supply power to at least one component of the electronic device 301. According to an embodiment, the battery 389 may include, for example, a primary cell which is not rechargeable, a secondary cell which is rechargeable, or a fuel cell.

The communication module 390 may support establishing a direct (e.g., wired) communication channel or a wireless communication channel between the electronic device 301 and the external electronic device (e.g., the electronic device 302, the electronic device 304, or the server 308) and performing communication via the established communication channel. The communication module 390 may include one or more communication processors that are operable independently from the processor 320 (e.g., the application processor (AP)) and supports a direct (e.g., wired) communication or a wireless communication. According to an embodiment, the communication module 390 may include a wireless communication module 392 (e.g., a cellular communication module, a short-range wireless communication module, or a global navigation satellite system (GNSS) communication module) or a wired communication module 394 (e.g., a local area network (LAN) communication module or a power line communication (PLC) module). A corresponding one of these communication modules may communicate with the external electronic device via the first network 398 (e.g., a short-range communication network, such as Bluetooth™, wireless-fidelity (Wi-Fi) direct, or infrared data association (IrDA)) or the second network 399 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 392 may identify and authenticate the electronic device 301 in a communication network, such as the first network 398 or the second network 399, using subscriber information (e.g., international mobile subscriber identity (IMSI)) stored in the subscriber identification module 396.

The wireless communication module 392 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 392 may support a high-frequency band (e.g., the mmWave band) to achieve, e.g., a high data transmission rate. The wireless communication module 392 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 392 may support various requirements specified in the electronic device 301, an external electronic device (e.g., the electronic device 304), or a network system (e.g., the second network 399). According to an embodiment, the wireless communication module 392 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 397 may transmit or receive a signal or power to or from the outside (e.g., the external electronic device) of the electronic device 301. According to an embodiment, the antenna module 397 may include an antenna including a radiating element composed of a conductive material or a conductive pattern formed in or on a substrate (e.g., a printed circuit board (PCB)). According to an embodiment, the antenna module 397 may include a plurality of antennas (e.g., array antennas). In such a case, at least one antenna appropriate for a communication scheme used in the communication network, such as the first network 398 or the second network 399, may be selected, for example, by the communication module 390 (e.g., the wireless communication module 392) from the plurality of antennas. The signal or the power may then be transmitted or received between the communication module 390 and the external electronic device via the selected at least one antenna. According to an embodiment, another component (e.g., a radio frequency integrated circuit (RFIC)) other than the radiating element may be additionally formed as part of the antenna module 397.

According to various embodiments, the antenna module 397 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 301 and the external electronic device 304 via the server 308 coupled with the second network 399. Each of the electronic devices 302 or 304 may be a device of a same type as, or a different type, from the electronic device 301. According to an embodiment, all or some of operations to be executed at the electronic device 301 may be executed at one or more of the external electronic devices 302, 304, or 308. For example, if the electronic device 301 should perform a function or a service automatically, or in response to a request from a user or another device, the electronic device 301, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 301. The electronic device 301 may provide the outcome, with or without further processing of the outcome, as at least part of a reply to the request. To that end, a cloud computing, distributed computing, mobile edge computing (MEC), or client-server computing technology may be used, for example. The electronic device 301 may provide ultra low-latency services using, e.g., distributed computing or mobile edge computing. In another embodiment, the external electronic device 304 may include an internet-of-things (IoT) device. The server 308 may be an intelligent server using machine learning and/or a neural network. According to an embodiment, the external electronic device 304 or the server 308 may be included in the second network 399. The electronic device 301 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

FIG. 3B illustrates an AR environment, according to an embodiment of the disclosure.

FIG. 3C illustrates a block diagram of an electronic device 301 (e.g., HMD 300c) for identifying a hand in the AR environment 300b, according to an embodiment of the disclosure.

The HMD 300c may refer to the HMD 305b of FIG. 3B.

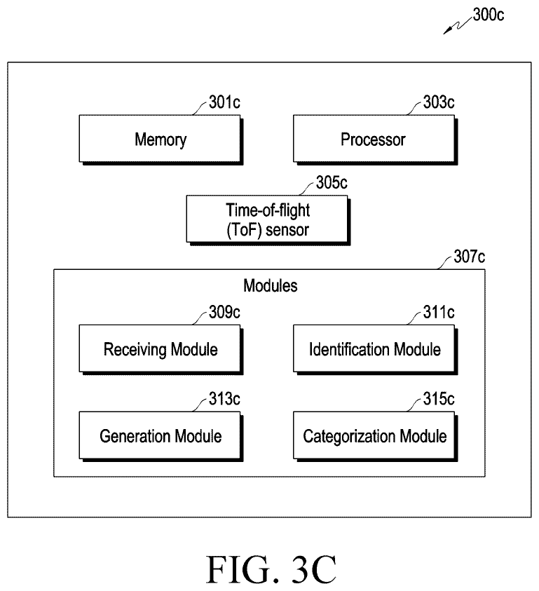

FIG. 4 illustrates a flow diagram depicting a method 400 for identifying a hand in an augmented reality based head mounted device (HMD), according to an embodiment of the disclosure.

For the sake of brevity, the description of FIGS. 3C and 4 are explained in conjunction with each other.

Referring to FIG. 3B, an AR scene 300b is depicted where a user 301b interacts with a real-world room setting 303b, which includes a person sitting in the room with dim light. The user 301b experiences the AR environment through a video-see-through (VST) device, such as a head-mounted display (HMD) 305b. The HMD is an electronic device worn around user's head which is configured to provide AR content/virtual reality (VR) content. An image-capturing device (not shown in FIG. 3B) may be connected to the HMD 305b via a network (not shown in FIG. 3B). The image-capturing device may be attached to or integrated within the HMD 305b. The image-capturing device may include the camera module 380. The image-capturing device may capture a plurality of images (e.g., real-world raw images). The at least one image captured by the image-capturing device may include the hand of the user. The electronic device (e.g., the HMD 305b) may determine whether the hand of the user is included in the plurality of images. For example, the electronic device 301 may determine whether the user's hand is included among the obtained the plurality of the images by using a template, stored in the electronic device 301, corresponding to a hand or a result of learning by intelligence application (e.g., Samsung® Bixby™). The image-capturing device (not shown in FIG. 3B) may transmit the plurality of real-world raw images to the HMD 305b. Accordingly, the image-capturing device may be facing the user 301b to capture the real-world raw images of the hand of the user 301b. The network may be a public communications network (e.g., the Internet, cellular data network, dialup modems over a telephone network) or a private communications network (e.g., private LAN, leased lines). As shown, the user 301b may navigate the AR scene 300b using his/her hands. For effective navigation, the HMD 305b may be able to distinguish between the left hand and the right hand. Accordingly, in an embodiment, the HMD 305b identifies the left hand and the right hand based on the real-world raw images using the techniques described below.

Referring to FIG. 3C, the HMD 300c may include, but is not limited to, memory 301c, a processor 303c, a time-of-flight (ToF) sensor 305c, and modules 307c. The memory 301c, the ToF sensor 305c, and the modules 307c may be coupled to the processor 303c.

The memory 301c may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes. Further, the memory 301 may include an operating system for performing one or more tasks of the HMD 300, as performed by a generic operating system in the communications domain.

The processor 303c can be a single processing unit or several units, all of which could include multiple computing units. The processor 303 may be implemented as one or more microprocessors, microcomputers, microcontrollers, digital signal processors, central processing units, state machines, logic circuitries, and/or any device that manipulates signals based on operational instructions. Among other capabilities, the processor 303 is configured to fetch and execute computer-readable instructions and data stored in the memory 301. In an embodiment, the processor 303 may be configured to perform the method as explained in reference to FIG. 4.

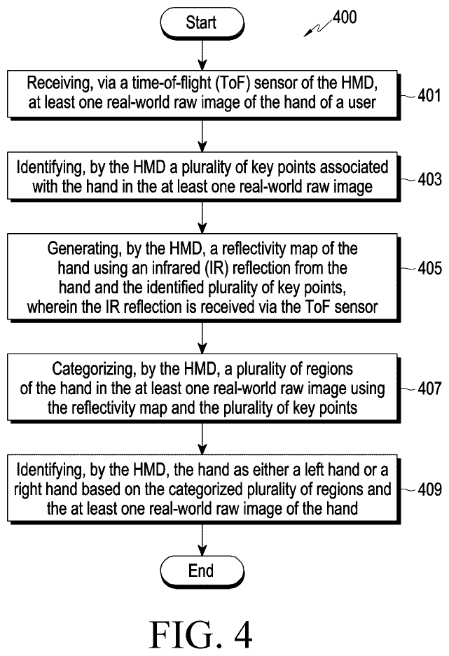

The ToF sensor 305c may be used to receive real-world raw images of the hand of the user 301b from the image-capturing device. In an embodiment, the ToF sensor is attached on the HMD 300c. The ToF sensor 305c has been further explained with respect to FIG. 5.

The modules 307c may include routines, programs, objects, components, data structures, etc., which perform particular tasks or implement data types. The modules 307c may also be implemented as signal processor(s), state machine(s), logic circuitries, and/or any other device or component that manipulates signals based on operational instructions.

Further, the modules 307c may be implemented in hardware, instructions executed by a processing unit, or by a combination thereof. The processing unit can comprise a computer, a processor, such as the processor 303c, a state machine, a logic array, or any other suitable wearable device capable of processing instructions. The processing unit can be a general-purpose processor which executes instructions to cause the general-purpose processor to perform the required tasks or, the processing unit can be dedicated to performing the required functions. In another embodiment of the disclosure, the modules 307c may be machine-readable instructions (software) that, when executed by a processor/processing unit, perform any of the described functionalities.

The modules 307c may include a set of instructions that may be executed by the processor 303 to cause the HMD 300c to perform any one or more of the methods disclosed herein. The modules 307 may be configured to perform the steps of the disclosure using the data stored in the memory 301c to identify the hand in the AR environment, as discussed throughout this disclosure. In an embodiment, each of the modules 307c may be hardware units that may be outside the memory 301c.

In the embodiment illustrated in FIG. 3C, the modules 307c may include a receiving module 309c, an identification module 311, a generation module 313, and a categorization module 315c.

The various modules 309c-315c may be in communication with each other. According to another embodiment of the disclosure, the processor 303c may be configured to perform the functions of modules 309c-315c.

It should be noted that that although the memory 301c, processor 303c, and various modules 307c are depicted as being part of a system within the HMD 300c, the said system could also be external to the HMD 300c and connected to the HMD 300c via the network.

Referring to FIG. 4, at operation 401, the at least one real-world raw image of the hand, herein referred to as the image, of the user 301b, is received. The receiving module 309 (e.g., the processor 120 of FIG. 3A) may receive (e.g., obtain) the image via the ToF sensor 305c from the image-capturing device. In other words, the electronic device (e.g., the HMD 300c) may obtain the image using the ToF sensor 305c.

At operation 403, a plurality of key points associated with the hand in the at least one real-world raw image are identified. The plurality of key points may include, but is not limited to, alignment of a wrist, type of fingers, location of the fingers, and location of finger-tip, locations of nails, locations of joints and/or an arrange of wrinkles in each of the fingers. The identification module 311 may identify the plurality of key points using techniques known in the art and hence, for the sake or brevity, these are not explained in detail here.

At operation 405, a reflectivity map of the hand is generated using an infrared (IR) reflection from the hand and/or the identified plurality of key points. The IR reflection is received via the ToF sensor 501.

Operation 405 is further explained with the help of FIG. 5.

FIG. 5 illustrates a scenario for generating the reflectivity map, according to an embodiment of the disclosure.

Referring to FIG. 5, the ToF sensor 501 may include an IR emitter 503 and an IR receiver 505. It should be noted that the ToF sensor 501 refers to the ToF sensor 305 of FIG. 3B. Typically, the ToF sensor 501 projects an IR beam/light of a particular frequency on various objects. Accordingly, the IR emitter 503 emits the IR beam which is reflected from the hand 507. The IR receiver 505 collects the light reflected from the hand 507. Every object absorbs and reflects a portion of the IR light that falls onto it differently. Similarly, the amount of IR light reflected by fingernails is different than that of skin regions. As shown in FIG. 5, the IR light reflected from the fingernails is stronger than the IR light reflected from the skin. Accordingly, the generation module 313 may generate the reflectivity map 509 based on the IR light reflected from the hand 507. According to an embodiment of the disclosure, the electronic device 301 may be configured to generate the reflectivity map 509 by using information on IR reflection included in the real-world raw image. According to an another embodiment of the disclosure, the electronic device 301 may be configured to generate the reflectivity map 509 by using information on IR reflection obtained at a different time from a time the real-world raw image is captured. For example, the electronic device 301 may be configured to output the IR toward a location where the hand is located after identifying the location where the hand is located in the real-world raw image. According to this, the electronic device 301 may be configured to obtain information on IR reflection with respect to the hand.

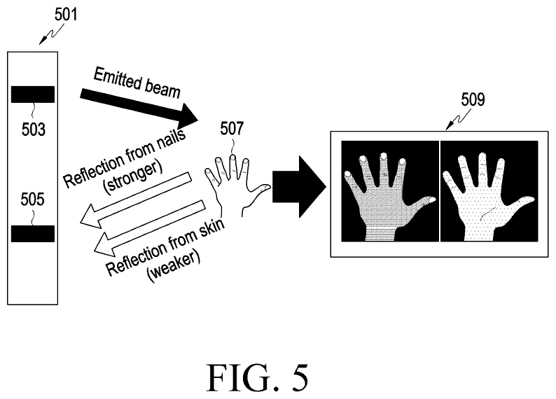

Referring back to FIG. 4, at operation 407, a plurality of regions of the hand in the at least one real-world raw image are categorized using the reflectivity map and the plurality of key points. In other words, the plurality of regions of the hand in the at least one real-world raw image are identified or grouped using the reflectivity map and the plurality of key points. The plurality of regions may include a nail region and a skin region of the hand. Operation 407 is further explained in detail with the help of FIG. 6.

FIG. 6 illustrates a workflow diagram of a categorization module, according to an embodiment of the disclosure.

Referring to FIG. 6, at block 601, the categorization module 315 (e.g., the processor 120 of FIG. 3A) may create a hand skeleton 601a from the at least one real-world raw image of the hand using the plurality of key points. The categorization module 315 may create the hand skeleton 601a using the techniques known to a person skilled in the art and hence, for the sake of brevity, these are not explained in detail here. At block 605, the categorization module 315 may compute a reflectivity gradient 605a corresponding to each finger of the hand skeleton 601a using the reflectivity map 603. The categorization module 315 may be configured to identify a location of each finger of the hand in the reflectivity map 603. For example, the categorization module 315 may identify a location of each finger of the hand in the reflectivity map 603 by comparing (e.g., overlaying) the reflectivity map 603 and the hand skeleton 601a. It should be noted that the reflectivity map 603 may refer to the reflectivity map 509 of FIG. 5. The reflectivity gradient 605a may indicate a level of reflectivity of the IR light from the hand. As the level of reflectivity from the skin and the fingernails of the hand varies, the corresponding reflectivity gradient changes accordingly. The categorization module 315 may interpret the reflectivity map 603 as a 2-dimensional (2D) surface and may compute a surface gradient, i.e., reflectivity gradient 605a to determine steepness in the reflectivity map 603. At block 607, the categorization module 315 may compute a surface curvature 607a corresponding to each finger based on a derivation in the reflectivity gradient 605a. At block 609, the categorization module 315 may detect a point of steep discontinuity 609b in the surface curvature 609a. The surface curvature may measure the amount of deviation at a given spatial location from being a flat plane. The categorization module 315 may detect the point of steep discontinuity where steepness has changed significantly. For example, the point of steep discontinuity may be detected around the circumference of the fingernails. This information may then be used to demarcate the skin from the nail. According to an embodiment of the disclosure, the point of steep discontinuity may be determined as follows:

Let F be the representation of the reflectivity map. F(x,y) is the reflectance value for the spatial co-ordinate x,y and may be defined as:

$${F}^{″} ( x , y ) = \frac{{\partial }^{2} F ( x , y )}{\partial x \partial y} \qquad Equation 1$$

Where F″(x, y) is curvature map. The categorization module 315 may use the curvature map to obtain points of steep discontinuity.

Accordingly, at block 611, the categorization module 315 may overlay the reflectivity map onto the at least one real-world raw image and then categorize a finger of the hand into the plurality of regions using the point of steep discontinuity. The categorization module 315 then similarly categorizes each finger of the hand. A demarcated/categorized hand is shown at block 611a, where the skin has been differentiated from the fingernails.

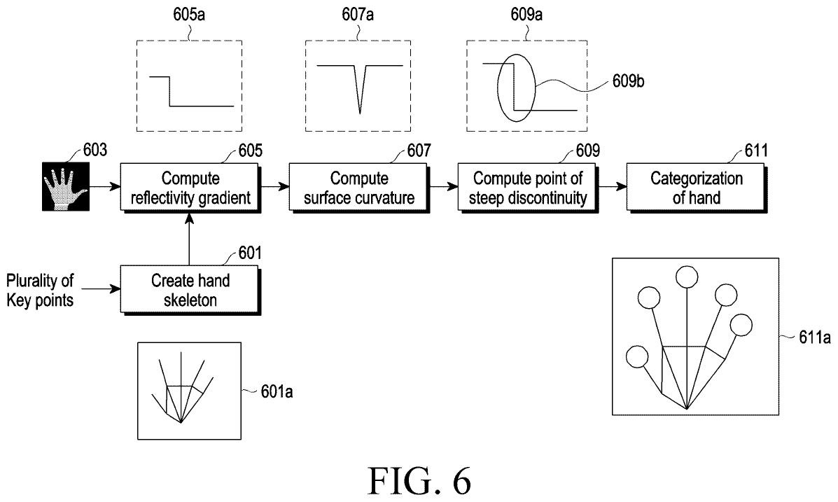

Referring to FIG. 4, at operation 409, the hand is identified as either the left hand or the right hand based on the categorized plurality of regions and the at least one real-world raw image of the hand. The identification module 311 (e.g., the processor 120 of FIG. 3A) may determine a view of the hand in the at least one real-world raw image based on a nail region. The view may correspond to one of a frontal view or a dorsal view of the hand. In particular, the identification module 311 may determine the view of the hand based on the nail region categorized by the categorization module 315. In order to identify the view of the hand, the identification module 315 may check if the length of a nail in the nail region is greater than a predetermined threshold. Accordingly, the identification module 315 may determine the view of the hand as the dorsal view, if the length of the nail is greater than the predetermined threshold. However, if the length of the nail is less than the predetermined threshold, then the identification module 315 may determine the view of the hand as the frontal view. The predetermined threshold may be defined by the identification module 315. Thereafter, the identification module 315 may obtain an orientation of the hand using a local coordinate system. In an embodiment, the identification module 315 may define the local coordinate system based on the alignment of a wrist and the location of a middle finger, as shown in FIG. 7.

FIG. 7 illustrates a local coordinate system, according to an embodiment of the disclosure.

Referring to FIG. 7, the local coordinate system may be defined by defining the Y-axis from the wrist to middle finger tip and X-axis in plane divided by Y-axis, where little finger of the hand lies. The identification module 315 may obtain the orientation of the hand using Maxwell's corkscrew law, i.e., identifying if the orientation of the thumb is upward or downward. For example, if the orientation of the thumb is upward, then the orientation of the hand is also upward. However, if the orientation of the thumb is downward, then the orientation of the hand is also downward. The identification module 215 may identify the hand as the left hand or the right hand based on the view of the hand and the hand orientation. When the view is the dorsal view, if the orientation of the hand is upward, then the identification module 315 may identify the hand as the right hand. However, if the orientation of the hand is downward in the dorsal view, then the identification module 315 may identify the hand as the left hand. Similarly, with respect to the frontal view, if the orientation of the hand is upward, then the identification module 315 may identify the hand as the left hand. However, if the orientation of the hand is downward, then the identification module 315 may identify the hand as the right hand.

Accordingly, the disclosure provides techniques for identification of the hand as the left hand or the hand in the AR environment.

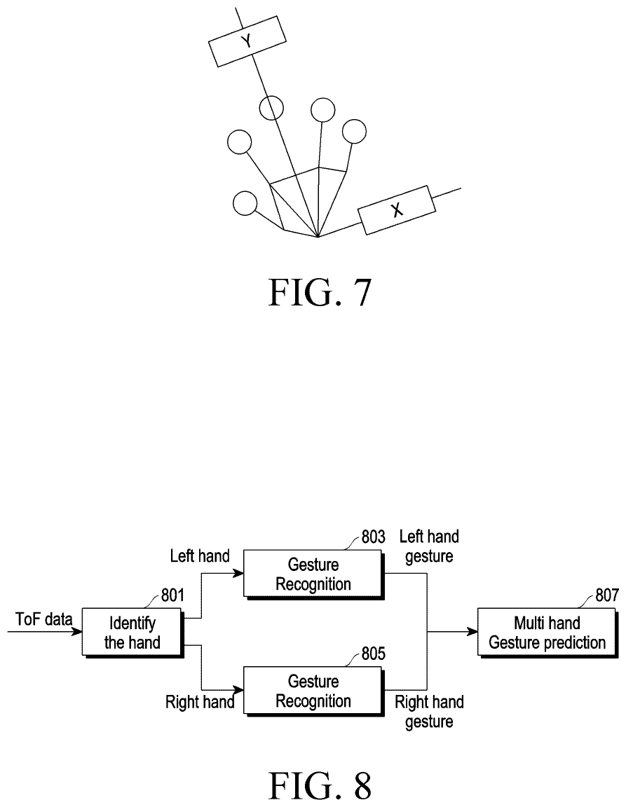

According to an embodiment, the disclosed techniques may be used in recognition gestures performed by a hand, as shown in FIG. 8. As gestures performed by different hands have different meanings, accurate identification of the hand as left hand or right hand, is required. Accordingly, the disclosed techniques may be helpful in the efficient recognition of the gestures performed by the hand.

FIG. 8 illustrates a block diagram for recognition of hand gesture, according to an embodiment of the disclosure.

Referring to FIG. 8, a multi hand gesture can be detected accurately in the dark. In the dark (or low-light), ToF is only sensor which is reliable. Accordingly, as shown in FIG. 8, the hand is identified as the left or right hand, at block 801. The identified hands may be used in any existing single hand gesture recognition module, such as gesture recognition modules 803 805 to identify the gesture performed by that hand, at block 807. For example, in case of gesture pinch and rotate gesture, where one hand performs pinch (user's dominant hand) and the other hand performs rotate action. For this gesture, accurate identification of the hand is required to identify the gesture. Another gesture is multi hand drag (or resize). In this gesture, if the respective hands move closer to each other, then the gesture is a resize small gesture. If the hands move in opposite directions, then the gesture is a resize big. However, accurate identification of the hand as the left or right hand is necessary to detect the gesture as inaccuracies can lead to different resize gesture impacting user experience.

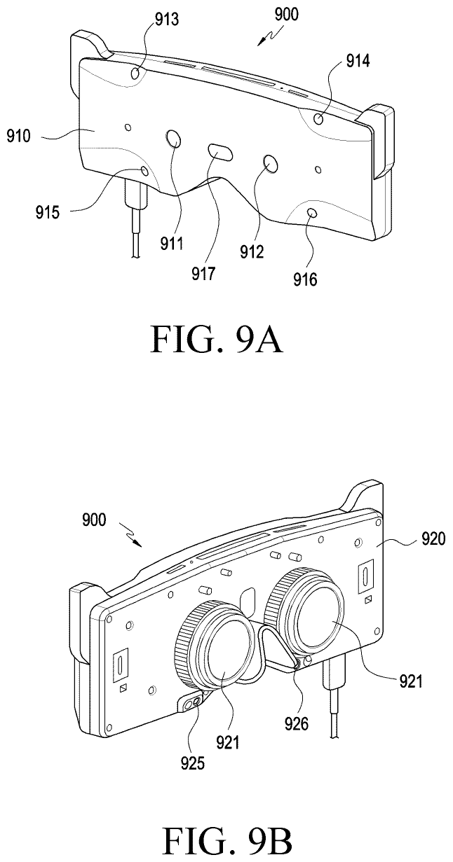

FIGS. 9A and 9B are diagrams illustrating an electronic device (e.g., the HMD 300c) according to various embodiments of the disclosure.

Referring to FIGS. 9A and 9B, in an embodiment, camera modules 911, 912, 913, 914, 915, and 916 and/or a depth sensor 917 for obtaining information related to the surrounding environment of the wearable device 200 may be disposed on a first surface 99 of the housing. In an embodiment, the camera modules 911 and 912 may obtain an image related to the surrounding environment of the wearable device. In an embodiment, the camera modules 913, 914, 915, and 916 may obtain an image while the wearable device is worn by the user. Images obtained through the camera modules 913, 914, 915, and 916 may be used for simultaneous localization and mapping (SLAM), 6 degrees of freedom (6DoF), 3 degrees of freedom (3DoF), subject recognition and/or tracking, and may be used as an input of the wearable electronic device by recognizing and/or tracking the user's hand. In an embodiment, the depth sensor 917 may be configured to transmit a signal and receive a signal reflected from a subject, and may be used to identify the distance to an object, such as time of flight (TOF). According to an embodiment, face recognition camera modules 925 and 926 and/or a display 921 (and/or a lens) may be disposed on the second surface 920 of the housing. In an embodiment, the face recognition camera modules 925 and 926 adjacent to the display may be used for recognizing a user's face or may recognize and/or track both eyes of the user. In an embodiment, the display 921 (and/or lens) may be disposed on the second surface 920 of the wearable device 900. In an embodiment, the wearable device may not include the camera modules 915 and 916 among a plurality of camera modules 913, 914, 915, and 916. As described above, the wearable device according to an embodiment may have a form factor for being worn on the user's head. The wearable device may further include a strap for being fixed on the user's body and/or a wearing member (e.g., the wearing member). The wearable device may provide a user experience based on augmented reality, virtual reality, and/or mixed reality within a state worn on the user's head.

According to another embodiment of the disclosure, the disclosed techniques may be used in accurately generating a hand mesh in the dark (or low-light. In the HMD, a hand mesh needs to be generated as it is the primary source of interaction. Hand mesh generation is a known technique which requires a hand mesh template, hand keypoints and then deforms the template to resemble the hand keypoints. These hand mesh template are pre-defined and are different for both hands. Only the correct pair of hand mesh and hand keypoints (left-left or right-right) can render the hand mesh for that corresponding hand correctly. Accordingly, in an embodiment, the disclosed techniques accurately identify the hand as the left or right hand in dark or low-light scenario, which is essential for hand mesh template selection.

Accordingly, the disclosure provides various advantages. For example, the disclosure provides techniques for accurate identification of the left hand and the right hand in the AR environment. The disclosure also results in enhanced hand tracking for VST devices, such as HMD, especially in low-light conditions.

The disclosure also enables user interaction with hand tracking to perform seamlessly even on inputs received only from the ToF sensor. Further, the disclosure discloses the generation of the reflectivity map at certain depths, which may also be expanded to applications in object interactions as well. For example, in applications where the hand is the primary mode of interaction, it is very important to differentiate left and right hands as different tasks are performed based on handedness. Accordingly, the disclosed techniques may be applied in any such application.

Unless otherwise defined, all technical and scientific terms used herein have the same meaning as commonly understood by one of ordinary skilled in the art to which this disclosure belongs. The system, methods, and examples provided herein are illustrative only and not intended to be limiting.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, ‘it will be understood by those skilled in the art that various changes in form and details may be made therein without departing from the spirit and scope of the disclosure as defined by the appended claims and their equivalents.

What is claimed is:

1. A method, performed by an electronic device, for identifying a hand, the method comprising:
obtaining, via a time-of-flight (ToF) sensor of the electronic device, at least one image, wherein the at least one image includes a hand, and the TOF sensor emits infrared (IR) light and receives IR reflection of the IR light emitted from the ToF sensor;
identifying, by the electronic device, a plurality of key points associated with the hand in the at least one image;
generating, by the electronic device, a reflectivity map of the hand based on the reflection of the IR light received by the ToF sensor;
identifying, by the electronic device, a plurality of regions of the hand in the at least one image using the reflectivity map and the plurality of key points; and
identifying, by the electronic device, the hand as either a left hand or a right hand based on the identified plurality of regions.

2. The method as claimed in claim 1, wherein identifying the plurality of regions comprises:
creating a hand skeleton from the at least one image of the hand using the plurality of key points;
computing a surface curvature corresponding to each finger of the skeleton based on a derivation in a reflectivity gradient corresponding to each finger of the hand skeleton; and
categorizing the each finger into the plurality of regions by overlaying the reflectivity map onto the at least one image and using a point of steep discontinuity in the surface curvature.

3. The method as claimed in claim 1, wherein identifying the hand as the left hand or the right hand comprises:
determining a view of the hand in the at least one image based on a nail region from the identified plurality of regions of the hand, wherein the view corresponds to one of a frontal view or a dorsal view of the hand;
obtaining an orientation of the hand using a coordinate system; and
identifying the hand as the left hand or the right hand based on the view of the hand and the hand orientation.

4. The method as claimed in claim 3, wherein determining the view of the hand in the at least one image comprises:
checking whether a length of a nail in the nail region is greater than a threshold; and
determining that the at least one image corresponds to the dorsal view based on the length of the nail being greater than the threshold.

5. The method as claimed in claim 3, wherein identifying the hand as the left hand or the right hand comprises:
based on the view being the dorsal view:
identifying the hand as the right hand based on the hand orientation being upward, and
identifying the hand as the left hand based on the hand orientation being downward; and
based on the view being the frontal view:
identifying the hand as the right hand based on the hand orientation being downward, and
identifying the hand as the left hand based on the hand orientation being upward.

6. The method as claimed in claim 1, wherein the plurality of key points includes alignment of a wrist, type of fingers, location of the fingers, and location of finger-tip in each of the fingers.

7. The method as claimed in claim 1, wherein the plurality of regions includes a nail region and a skin region of the hand.

8. The method as claimed in claim 3, wherein the coordinate system is defined based on an alignment of a wrist and location of a middle finger.

9. An electronic device, comprising:
memory storing one or more computer programs;
a time-of-flight (ToF) sensor; and
one or more processors communicatively coupled to the memory and the ToF sensor,
wherein the one or more computer programs include computer-executable instructions that, when executed by the one or more processors individually or collectively, cause the electronic device to:
obtain, via the ToF sensor, at least one image, wherein the at least one image includes a hand, and the TOF sensor emits infrared (IR) light and receives IR reflection of the IR light emitted from the ToF sensor,
identify a plurality of key points associated with the hand in the at least one image,
generate a reflectivity map of the hand based on the reflection of the IR light received by the ToF sensor,
identify a plurality of regions of the hand in the at least one image using the reflectivity map and the plurality of key points, and
based on the identified plurality of regions, identify the hand as either a left hand or a right hand.

10. The electronic device as claimed in claim 9, wherein the one or more computer programs further include computer-executable instructions that, when executed by the one or more processors individually or collectively, cause the electronic device to identify the plurality of regions by:
creating a hand skeleton from the at least one image of the hand using the plurality of key points;
computing a surface curvature corresponding to each finger of the skeleton based on a derivation in a reflectivity gradient corresponding to each finger of the hand skeleton; and
categorizing the each finger into the plurality of regions by overlaying the reflectivity map onto the at least one image and using a point of steep discontinuity in the surface curvature.

11. The electronic device as claimed in claim 9, wherein the one or more computer programs further include computer-executable instructions that, when executed by the one or more processors individually or collectively, cause the electronic device to identify the hand as the left hand or the right hand by:
determining a view of the hand in the at least one real-world raw image based on a nail region from the identified plurality of regions of the hand, wherein the view corresponds to a frontal view or a dorsal view of the hand;
obtaining an orientation of the hand using a coordinate system; and
identifying the hand as the left hand or the right hand based on the view of the hand and the hand orientation.

12. The electronic device as claimed in claim 11, wherein the one or more computer programs further include computer-executable instructions that, when executed by the one or more processors individually or collectively, cause the electronic device to determine the view of the hand in the at least one real-world raw image by:
checking whether a length of a nail in the nail region is greater than a threshold; and
determining that the at least one image corresponds to the dorsal view based on the length of the nail being greater than the threshold.

13. The electronic device as claimed in claim 11, wherein the one or more computer programs further include computer-executable instructions that, when executed by the one or more processors individually or collectively, cause the electronic device to identify the hand as the left hand or the right hand by:
based on the view being the dorsal view:
identifying the hand as the right hand based on the hand orientation being upward, and
identifying the hand as the left hand based on the hand orientation being downward; and
based on the view being the frontal view:
identifying the hand as the right hand based on the hand orientation being downward, and
identifying the hand as the left hand based on the hand orientation being upward.

14. The electronic device as claimed in claim 9, wherein the plurality of key points includes alignment of a wrist, type of fingers, location of the fingers, and location of finger-tip in each of the fingers.

15. The electronic device as claimed in claim 9, wherein the plurality of regions includes a nail region and a skin region of the hand.

16. The electronic device as claimed in claim 11, wherein the one or more computer programs further include computer-executable instructions that, when executed by the one or more processors individually or collectively, cause the HMD to define the coordinate system based on an alignment of a wrist and location of a middle finger.

17. The electronic device as claimed in claim 16, wherein a Y-axis of the coordinate system is defined from the wrist of the hand to the tip of the middle finger, and an X-axis of the coordinate system is defined as a plane divided by the Y-axis where the little finger of the hand lies.

18. The electronic device as claimed in claim 11, wherein the ToF sensor comprises:
an IR emitter configured to emit IR light; and
an IR receiver configured to receive the IR reflection.

19. One or more non-transitory computer-readable storage media storing one or more computer programs including computer-executable instructions that, when executed by one or more processors of an electronic device individually or collectively, cause the electronic device to perform operations, the operations comprising:
obtaining, via a ToF sensor of the electronic device, at least one image, wherein the at least one image includes a hand, and the TOF sensor emits infrared (IR) light and receives IR reflection of the IR light emitted from the ToF sensor,
identifying a plurality of key points associated with the hand in the at least one image,
generating a reflectivity map of the hand based on the reflection of the IR light received by the ToF sensor,
identifying a plurality of regions of the hand in the at least one image using the reflectivity map and the plurality of key points, and
based on the identified plurality of regions, identifying the hand as either a left hand or a right hand.

20. The one or more non-transitory computer-readable storage media of claim 19, wherein the plurality of key points includes alignment of a wrist, type of fingers, location of the fingers, and location of finger-tip in each of the fingers.
